(19) United States
(12) Patent Application Publication
(10) Pub. No.: US 2006/0152338 A1
(43) Pub. Date: Jul. 13, 2006

(54) Remote control system and method for home items

(75) Inventor: Shou-Kuo Hsu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/302,833

(22) Filed: Dec. 14, 2005

(30) Foreign Application Priority Data
Dec. 25, 2004 (CN) 200410091893.1
Dec. 28, 2004 (CN) 200410091936.6

(51) Int. Cl. G05B 23/00

(52) U.S. Cl. 340/5.5; 340/10.5; 340/5.6; 370/310

(57) ABSTRACT

A remote control system for home items includes: a radio frequency identification (RFID) system, including an RFID reader, an antenna, and one or more RFID tags, each of the RFID tags being for attachment to a respective home item and for collecting and storing information on a status of the home item, wherein when the RFID reader sends radio frequency signals via the antenna to activate any one or more of the RFID tags, one or more of the RFID tags transmits the stored information to the RFID reader via the antenna, and the RFID reader receives and processes the information; and a computer network comprising one or more computers linked to the RFID reader, for receiving the information sent by the RFID reader and controlling the functions of the home items. A related remote control method is also provided.

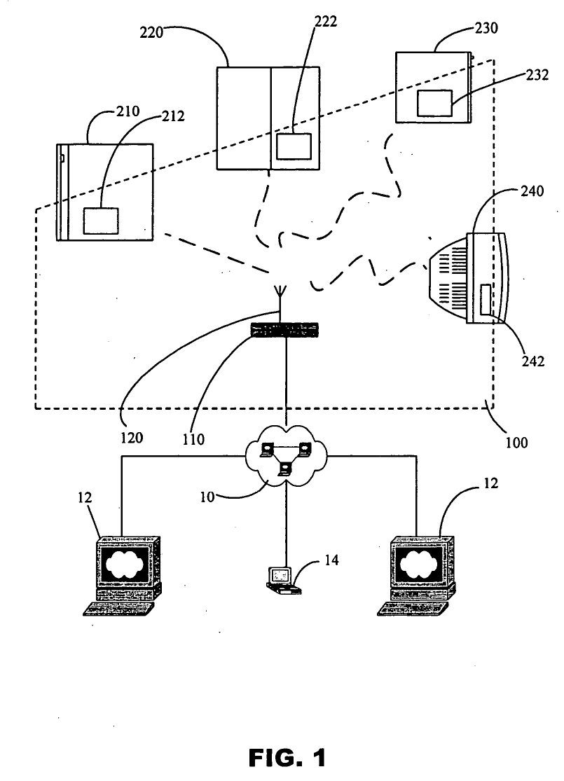

### CROSS-REFERENCE TO RELATED APPLICATION

Reference is made to the copending U.S. patent application entitled “REMOTE CONTROL SYSTEM AND METHOD FOR HOME ITEMS”, assigned to the same assignee as that of the present invention.

### BACKGROUND

1. Field of the Invention

The present invention relates to remote control systems and methods, and particularly to a remote control system and method for home items.

2. General Background

Digital technology has developed rapidly and spread through various areas of peoples' lives since the 1990s. As computer and communications networks enter ordinary family life more and more, electronic products, computers, and various communication means are becoming integrated, and intelligent information products are progressively changing the lifestyles of families and society. Intelligent home appliances such as security systems are becoming fashionable in modern society and families because they have advantages such as safety, convenience, high efficiency, and high speed. The remote controlling of products in the home has become a popular field of research.

Radio frequency identification (RFID) is a means of remote automatic identification of a desired target such as an object or even an animal. RFID uses radio frequency signals to transmit information via space coupling, and thereby achieves identification. Applications of RFID include areas such as wild animal tracking and identifying customers' cars for levying of parking charges. RFID has also been use of to identify one of a plurality of items having the same or a similar appearance, such as luggage or a waste container.

What is desired is a remote control system which is able to incorporate a computer network with RFID for remote monitoring and controlling of the functions of various home items such as doors, windows and electrical appliances.

### SUMMARY

A remote control system for home items is provided. In a preferred embodiment, the remote control system comprises: a radio frequency identification (RFID) system, comprising an RFID reader, an antenna, and one or more RFID tags, each of the RFID tags being for attachment to a respective home item and for collecting and storing information on a status of the home item, wherein when the RFID reader sends radio frequency signals via the antenna to activate any one or more of the RFID tags, one or more of the RFID tags transmits the stored information to the RFID reader via the antenna, and the RFID reader receives and processes the information; and a computer network comprising one or more computers linked to the RFID reader, for receiving the information sent by the RFID reader and controlling the functions of the home items. A related remote control method is also provided.

The remote control system incorporates a computer network with an RFID system. Therefore users are able to monitor and control the functions of the home items even when they are absent from their homes.

Other advantages and novel features will become more apparent from the following detailed description of preferred embodiments when taken in conjunction with the accompanying drawing, in which:

### BRIEF DESCRIPTION OF THE DRAWING

The drawing is a schematic diagram of a remote control system for home items in accordance with a preferred embodiment of the present invention.

### DETAILED DESCRIPTION OF THE EMBODIMENTS

The drawing is a schematic diagram of a remote control system for home items in accordance with a preferred embodiment of the present invention. The remote control system includes a computer network 10, a radio frequency identification (RFID) system 100, and home items such as a door 210, a window 220, a microwave oven 230, and a television 240.

The computer network 10 includes a plurality of digitally computing device like a desktop computer 12 and a notebook computer 14. The desktop computer 12 and the notebook computer 14 can communicate with each other and with an external network such as the Internet (not shown). The RFID system 100 includes an RFID reader 110, an antenna 120, and a plurality of RFID tags 212, 222, 232, 242. Each of the RFID tags 212, 222, 232, 242 is set in a respective one of the home items 210, 220, 230, 240, for collecting and storing information on the status of respective home item 210, 220, 230, 240 at any moment in time. The RFID reader 110 sends radio frequency signals of a characteristic frequency via the antenna 120. The RFID tags 212, 222, 232, 242 can generate induced current, and are activated when the radio frequency signals cover an area within which the RFID tags 212, 222, 232, 242 are positioned. Then the RFID tags 212, 222, 232, 242 transmit the stored information to the RFID reader 110 via the antenna 120. The RFID reader 110 receives and processes the information. The computer network 10 communicates with the RFID reader 110 via TCP/IP (Transmission Control Protocol/Internet Protocol).

When users want to know or alter the status of any of the home items 210, 220, 230, 240, they can input a set of instructions to the desktop computer 12 or the notebook computer 14. Then the instructions are transmitted to the RFID reader 110. The RFID reader 110 transmits the instructions to the RFID tags 212, 222, 232, 242 via the antenna 120. The RFID tags 212, 222, 232, 242 receive and are activated by the instructions, and act on the instructions by transmitting information on the statuses of the home items to the RFID reader 110. The RFID reader 110 decodes the information, and passes it on to the computer network 10. By inputting control instructions to the desktop computer 12 or the notebook computer 14, the users are able to control the functions of the home items 210, 220, 230, 240. For example, a user can turn on or turn off a home appliance such as the microwave oven 230 or the television 240. In another example, a user can adjust the temperature of an air conditioner according to a change in the weather.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A remote control system for one or more home items, comprising:
a radio frequency identification (RFID) system, comprising an RFID reader, an antenna, and one or more RFID tags, each of the RFID tags being for attachment to a respective home item and for collecting and storing information on a status of the home item, wherein when the RFID reader sends radio frequency signals via the antenna to activate any one or more of the RFID tags, one or more of the RFID tags transmits the stored information to the RFID reader via the antenna, and the RFID reader receives and processes the information; and
a computer network comprising one or more computers linked to the RFID reader, for receiving the information sent by the RFID reader and controlling the functions of the home items.

2. The system as claimed in claim 1, wherein the computers communicate with the RFID reader via TCP/IP (Transmission Control Protocol/Internet Protocol).

3. The system as claimed in claim 1, wherein the home items comprise one or more pieces of electrical equipment.

4. The system as claimed in claim 1, wherein the home items comprise items selected from the group consisting of a door and a window.

5. A method for remote control of one or more home items, comprising the steps of:
providing a radio frequency identification (RFID) system, the RFID system comprising an RFID reader, an antenna, and one or more RFID tags, each of the RFID tags attached to a respective home item, for collecting and storing information on a status of the home item;
sending radio frequency signals from the RFID reader to activate one or more of the RFID tags;
transmitting the stored information from one or more of the RFID tags to the RFID reader, and receiving and processing the information; and
providing one or more computers linked to the RFID reader, for receiving the information sent by the RFID reader, and controlling one or more functions of the home items.

6. The method as claimed in claim 5, wherein the computers communicate with the RFID reader via TCP/IP (Transmission Control Protocol/Internet Protocol).

7. The method as claimed in claim 5, wherein the home items comprise one or more pieces of electrical equipment.

8. The method as claimed in claim 5, wherein the home items comprise items selected from the group consisting of a door and a window.

9. A method for remote control of home items in a household, comprising the steps of:
establishing a radio frequency identification (RFID) system in a household so as to control information of home items in said household via RFID technology respectively;
communicating said RFID system with at least one remote digitally computing device; and
controlling each of said home items in said household based on said information by using said remote digitally computing device.

10. The method as claimed in claim 9, wherein said RFID system is communicable with said at least one remote digitally computing device via Transmission Control Protocol/Internet Protocol (TCP/IP).
